(19) United States
(12) Patent Application Publication
(10) Pub. No.: US 2008/0014035 A1
(43) Pub. Date: Jan. 17, 2008

(54) Clamping Tool And Hole Saw Apparatus

(75) Inventors: Michael P. Perkovich, Sheffield Lake, OH (US); Jack I. Mantz, Norton, OH (US); Stanley J. Nerderman, Kirtland, OH (US)

Correspondence Address: LEGAL DEPARTMENT;LUBRIZOL ADVANCED MATERIALS, INC, 9911 BRECKSVILLE ROAD, CLEVELAND, OH, 44141-3247, US

(73) Assignee: Noveon IP Holdings Corp., Cleveland, OH (US)

(21) Appl. No.: 11/427,920

(22) Filed: Jun. 30, 2006

(51) Int. Cl. B23B 47/28

(52) U.S. Cl. 408/1 R

(57) ABSTRACT

Apparatus and method for using a portable tool for assisting the making of holes in pipes to prepare for interconnected branch or cross lines. The apparatus includes a guide member and a plurality of bushings able to accommodate a plurality of hole saws of varying diameters. The apparatus includes a stop member to prevent inadvertent sawing of the opposite internal pipe wall. The apparatus includes a drill bit able to span the internal diameter of the pipe to create a pilot hole to mark the centerline of the cross hole to be sawed.

### BACKGROUND OF THE INVENTION

1. Field of Invention

The invention relates to cutting tools and methods of operation. An exemplary form of the invention relates to providing a system for using a portable tool for assisting in the making of holes in installed pipes, such as in water pipes and the like to prepare for interconnected piping. More particularly, this exemplary form of the invention provides an apparatus and method for forming branch and cross lines in CPVC piping networks.

2. Description of the Related Art

Many buildings are required by code to have fire suppression sprinkler systems. Further, residential structures are increasingly being provided with fire suppression systems. CPVC piping systems are ideally suited for fire sprinkler system applications because of their resistance to flame, corrosion, the lightness of material, ease of installation, and the like.

Under current standards, in-line coupling of abutting CPVC pipe sections is accomplished by use of solvent cement techniques to form a permanent bond therebetween. Such techniques require sufficient time for the solvent cement to cure. Furthermore, at times it may become necessary to make modifications or repairs to existing CPVC fire sprinkler systems. The use of solvent cement demands that the modification to the pipe network must be accomplished in a dry environment.

In use, fire sprinkler systems are under continuous water pressure. In prior systems, for a system modification or repair, the targeted sprinkler section must be removed from service and dried. The new pipe sections must be adhered by solvent cement which requires an applicable cure time. Thereafter, the system is brought back online and tested. During this process, which may extend over 24 hours or longer, at least a portion of the fire sprinkler system is out of service, requiring an alternate fire watch. Other desired configurations or modifications of a CPVC pipe network may include branched connections from a first pipe line to a perpendicular pipe line. In the art, a cut-in to an existing CPVC fire sprinkler system is made by shutting down the system and drying. An appropriate socket style tee fitting is used in combination with socket unions, grooved coupling adapters, and flanges. The fitting is adhered to the cut pipe ends using solvent cement. Care must be taken to follow cut-in cure schedules for the solvent cement. Similar to in-line coupling, the process requires considerable down time of the sprinkler system as well as an alternate fire watch method. Thus, there exists a need in the art for cut-in fittings and procedures that significantly reduce downtime of the sprinkler system, while still providing a system that meets stringent fire protection standards.

The use of alternate joining mechanisms, such as mechanical fixtures, requires development of innovative pipe drilling methods and devices which provide for installation and repair of branch cut-ins and tees while preserving the structural integrity of the CPVC piping.

Typically, when pipe fitting, or more specifically, drilling holes in the wall of round pipe, a substantial challenge is encountered. The difficulty is related to locating, positioning, and holding the hole-cutting means, e.g., a drill, in a stable and accurate manner. When holes are predrilled in a machine shop, prior to installation of the pipe in a system, common machine tools and fixtures are used and these generally reduce the difficulty of the task. However, when performing this task in the field on pipes already installed, such machine tools and fixtures are not available or possible to use. When field fitting piping, such as piping used for sprinkler systems, locations for interconnecting runs might not be easily predetermined, particularly if a branch run is later added to a previously installed system. When drilling a hole into the round surface of pipe, a hole saw is commonly used. The hole saw, cuts or saws the “circular” border of the hole.

The hole saw may use a pilot drill bit to first engage the pipe and then to position the round hole saw as the pipe is sawed into. A difficulty occurs because the saw teeth do not evenly engage the curved surface of the pipe, often resulting in the teeth unevenly grabbing and jerking the saw. As a result, this common piping job is currently a difficult operation to perform in the field.

A portable tool for guiding a hole saw for making a hole in only a first side of a hollow installed pipe is disclosed in U.S. Pat. No. 5,800,099 to Cooper.

Further, there exists a need in the art for an apparatus operative to provide precise drilling of CPVC pipe for direct cut-in.

It is one objective of exemplary embodiments to address the difficulties described above and to provide a tool which is simple, lightweight, and portable.

It is another objective of exemplary embodiments to provide a tool kit which may be utilized to add holes for branch lines of varying diameters into installed pipes of varying diameters.

These and other objects of exemplary embodiments will become apparent to those of skill in the art with reference to the following disclosure.

### SUMMARY OF THE INVENTION

In an exemplary embodiment, there is provided an apparatus including a hole saw having a forward cutting edge; a stop member disposed from the forward cutting edge a predetermined distance; and a portable tool including a guide member and a clamping mechanism in supporting connection with the guide member. The clamping mechanism is operative to securely hold the guide member relative to a pipe to be sawed. The guide member includes an axial opening adapted for reception of the hole saw therein

In an exemplary embodiment, the apparatus further includes at least one selectable drill bit, wherein when selected, the drill bit is disposed along an axis of the hole saw, wherein the selected drill bit has a length sufficient to provide a pilot hole in the pipe to be sawed.

In an exemplary embodiment, the selected drill bit has a length sufficient to span the internal diameter of the pipe to be sawed.

In an exemplary embodiment, the apparatus further includes a plurality of hole saws that can be used to selectively replace the first hole saw, wherein each of the hole saws comprises a cylindrical body having a corresponding predetermined diameter.

In an exemplary embodiment, the portable tool includes a plurality of bushings operative to selectively adjust a size of the axial opening in the guide member to accommodate a plurality of hole saws.

In an exemplary embodiment, the guide member is enabled to cooperate with the stop member to limit axial movement of the hole saw in the axial opening of the guide member.

In an exemplary embodiment, the stop member comprises a radially extending member adjacent an end of the hole saw opposite the forward cutting edge. The stop member and the hole saw may include discrete components. Alternately, the stop member and the hole saw may comprise an integral assembly.

In an exemplary embodiment, there is provided a method for drilling one or more holes into a pipe. The method includes engaging a pipe to be sawed with a portable tool, wherein the portable tool includes a guide member and a clamping mechanism operative to securely hold the guide member in a user determined position relative the pipe to be sawed. The method also includes penetrating a pipe wall with a forward cutting edge of a first hole saw received within the axial opening, whereby a first sawed hole corresponding to a diameter of the first hole saw is formed in the pipe wall. The method utilizes a stop member in cooperation with the guide member to prevent the forward cutting edge from internally contacting the pipe wall at a position diametrically opposed to the first sawed hole.

An exemplary method includes, without repositioning the portable tool, providing an internal alignment marking in the pipe wall at the diametrically opposed position. In an exemplary method, providing the internal alignment marking includes disposing a drill bit along an axis of the first hole saw, wherein the drill bit has a length sufficient to span an internal diameter of the pipe, and engaging an internal surface of the pipe wall with the drill bit at the diametrically opposed position.

An exemplary method includes repositioning the portable tool to enable a second sawed hole to be formed in the pipe wall at the diametrically opposed position.

An exemplary method includes selectively adjusting a size of the axial opening of the guide member to accommodate a second hole saw differing in diameter from the first hole saw.

An exemplary method includes connecting a branch pipe length in fluid communication with the pipe through the first sawed hole. In an exemplary method, connecting the branch pipe length with the pipe includes using a mechanical fastener.

An exemplary method includes connecting a first branch pipe length in fluid communication with the pipe through the first sawed hole, and connecting a second branch pipe length in flow communication with the pipe through the second sawed hole, wherein the first and second branch pipe lengths are substantially coaxial.

An exemplary method includes using a drill bit to form a pilot hole in the pipe wall and retaining a coupon of the sawed hole with the drill bit.

An exemplary method includes guiding a hole saw through an axial opening in a guide member, wherein the hole saw includes a forward cutting edge; penetrating a pipe wall with the hole saw thereby forming a first sawed hole in the pipe wall; engaging a stop member with the guide member after the hole saw has penetrated the pipe wall and before the forward cutting edge engages the pipe wall at a diametrically opposed position.

An exemplary method includes providing an internal alignment marking in the pipe wall at a diametrically opposed position. Providing the internal alignment marking may include disposing a drill bit along an axis of a hole saw, and engaging an internal surface of the pipe wall with the drill bit at the diametrically opposed position. In an exemplary embodiment, the internal alignment marking may include an alignment hole extending from the internal surface to an external surface of the pipe wall.

### BRIEF DESCRIPTION OF THE DRAWINGS

The foregoing summary, as well as the following detailed description of exemplary embodiments, will be better understood when read in conjunction with the drawings which are a part of the present application. For the purpose of illustrating the invention, there is shown in the drawings certain exemplary embodiments. It should be understood, however, that the invention is not limited to the precise arrangements and instrumentalities shown. In the drawings:

FIG. 1 is a perspective view of an exemplary embodiment of a portable clamping tool and hole saw apparatus shown in position for use in making a hole in the sidewall of a round pipe.

FIG. 2 is a cross sectional view of an exemplary clamping tool and hole saw apparatus illustrating a hole saw position prior to engagement with a pipe wall.

FIG. 3 is a cross sectional view of an exemplary clamping tool and hole saw apparatus illustrating a hole saw position subsequent to engagement with a pipe wall.

FIG. 4 is a cross sectional view of an alternate embodiment of a clamping tool and hole saw apparatus illustrating a drill bit providing an internal marking hole.

FIG. 5 is a perspective view illustrating selectively replaceable bushings and hole saws.

FIG. 6 is an exploded perspective view of a cross-cut pipe and an exemplary gasketed clamp fitting.

FIG. 7 is a partial perspective view of a pipe and a cross line.

FIG. 8 is a perspective view of a tool kit including a portable tool, a plurality of hole saws, a plurality of drill bits, a plurality of bushings, and a stop member.

### DETAILED DESCRIPTION OF EXEMPLARY EMBODIMENTS AND THE BEST MODE OF PRACTICE

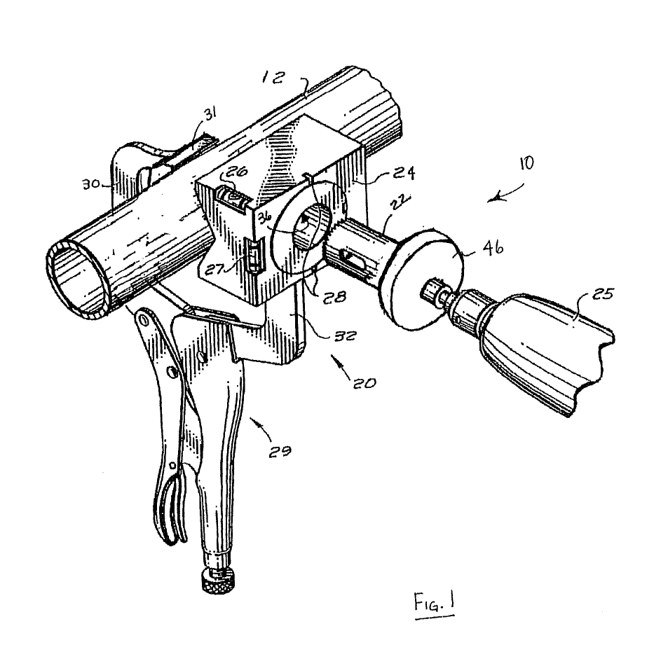

Illustrated in FIG. 1, is an apparatus 10 for making a sawed hole in a pipe 12. The apparatus includes a portable tool 20, and a hole saw 22.

The portable tool 20 may be similar in construction to a tool disclosed in U.S. Pat. No. 5,800,099 to Cooper, which is fully incorporated herein by reference. The incorporated reference discloses a tool and methods to assist the use of a hole saw for making a hole in only a first side of a hollow installed pipe. Disclosed herein are devices and methods that may be used to form cross-cuts in pipes so that diametrically opposed or other branch lines may readily be installed in flow communication with the pipe. The branch lines may be the same or different diameters.

In an exemplary embodiment, the pipe 12 to be sawed is formed of a chlorinated polyvinyl chloride (CPVC) composition particularly intended for use in a network of pipes for a fire sprinkler system, although the invention is not so limited. For example, the apparatus and methods disclosed herein may be used on pipes formed of metal or other plastic material, such as PVC. The preferred type of CPVC resin of which the pipe is comprised is sold under the BLAZEMASTER® brand name. Table 1 below, provides the physical and thermal characteristics of an exemplary CPVC composition. Of course, the pipe 12 may be used for other purposes such as supplying other liquids or air. In an exemplary embodiment, the pipe 12 may be a previously installed pipe to which a branch- or cross-line is to be added. The sawed hole would then be used for connecting with a branch pipe.

TABLE 1

| | BLAZEMASTER ® | |
|---|---|---|
| Property | Brand CPVC | ASTM |
| Specific Gravity, “Sp. Gr.” | 1.55 | D792 |
| IZOD Impact Strength (ft.lbs./inch | 1.5 | D256A |
| notched) | | |
| Modulus of Elasticity, @73EF psi, “E” | 4.23 × 10⁵ | D638 |
| Compressive Strength, psi, “o” | 9,600 | D695 |
| Poisson's Ratio, “O” | .35–.38 | — |
| Working Stress @ 73EF, psi, “S” | 2,000 | D1598 |
| Hazen Williams Factor “C” | 150 | — |
| Coefficient of Linear Expansion, | 3.4 × 10⁻⁵ | D696 |
| in/(in E F), “e” | | |
| Thermal Conductivity, | 0.95 | D177 |
| BTU/hr/ft²/EF/in, “k” | | |
| Flash Ignition Temperature, EF | 900 | D1929 |
| Limiting Oxygen Index, “LOI” | % 60 | D2863 |
| Electrical Conductivity | Non Conductor | — |
| Extrusion Temperature | 414–425 EF (approx.) | N/A |
| Heat Distortion Temperature, EF | 217 | — |

For applications involving CPVC pipes for use in fire sprinkler systems, for example, the pipe diameter may be two, two and a half, or three inches. The hole to be sawed may be, for example, one and a half, one and three quarters, or two inches. The devices and methods disclosed herein are not limited to the present customary hole sizes and pipe diameters, but may be adapted to accommodate any size hole to be sawed into a pipe of any diameter.

In an exemplary embodiment, the portable tool 20 includes a guide member 24. The hole saw 22 may be driven by a power drill or other suitable device 25. As described more fully in the incorporated disclosure, the guide member 24 may include a horizontal level 26, a vertical level 27, and center guides 28 to facilitate locating a user-determined position for forming a sawed hole.

The exemplary guide member 24 is mounted in supporting connection with a clamping mechanism 29 which may be an adjustable, locking C-clamp. Clamping mechanism 29 is operative to engage the pipe to be sawed such that the guide member 24 is securely held in a user-determined position. In an exemplary embodiment, the clamping mechanism includes a relatively movable jaw 30 and a fixed jaw 32. In an exemplary embodiment, guide member 24 is fixedly secured to fixed jaw 32 and a swivelable clamp-head 31 is non-rigidly affixed to movable jaw 30. Other constructions, such as a removable guide member, are contemplated within the scope of the invention.

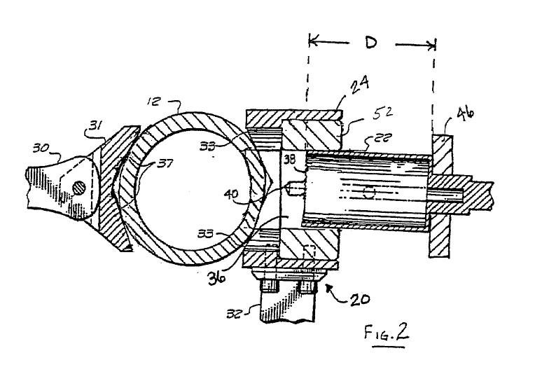

As illustrated in FIG. 1, the exemplary form of portable tool 20 may be accurately and easily positioned on pipe 12 for sawing a hole therein. With reference to FIG. 2, hole saw 22 is illustrated in a position immediately prior to sawing a hole of desired diameter in a pipe wall at a first location. Prior to forming the hole, the exemplary portable tool 20 is clamped in a user-determined position relative pipe 12. The user-determined position may be established by using the positioning features of the portable tool, shown in FIG. 1, in accordance with the teachings of the incorporated reference. In an exemplary embodiment, guide member 24 includes a generally V-shaped holding surface 33 to assist in positioning the guide member relative pipe 12. Movable jaw 30 pivots relative to fixed jaw 32 so that swivelable clamp-head 31 contacts pipe 12. Although illustrated as being positioned generally diametrically opposed to the guide member 24, it should be readily apparent that the contact location of clamp-head 31 necessarily varies depending on the diameter of pipe 12. The exemplary clamp-head 31 includes a holding surface 37, also V-shaped, to provide uniform contact with pipe 12. Clamping mechanism 29 is utilized to retain the portable tool 20 in the user determined position as the hole is sawed. In certain embodiments, holding surface 37 may incorporate teeth or other features to provide better grip on pipe 12. However, if a cross-line is planned to be fluidly connected to pipe 12 such that a hole will also be formed in the position diametrically opposed to the first hole, care should be taken to prevent excess marring of the pipe surface for correct operation of gasketed clamp fittings as is discussed in further detail below. Thus, in some embodiments, holding surface 37 may be smooth or only moderately toothed or otherwise configured or comprised of material to provide sufficient grip while avoiding unacceptable deformation of the outer pipe surface. In other embodiments, alternate, selectively replaceable clamp-heads 31 may be provided with different surfaces and properties depending on the particular circumstances.

The size of the hole to be sawed into pipe 12 is dependent upon the diameter of hole saw 22. Guide member 24 includes an axial opening 36 adapted to receive the hole saw 22 therein in generally close fitting relation. Hole saw 22 is adapted for axial movement in the axial opening 36 of the guide member 24. As explained in greater detail below, the dimension of axial opening 36 may be varied depending on the desired diameter of the drilled hole.

As the forward cutting edge 38 rotates and contacts the first side of the pipe to be sawed, a portion of hole saw 22 remains within the axial opening 36 to support and guide the hole saw 22. As illustrated in FIG. 2, a drill bit 40 may be utilized to drill an initial pilot hole in the first side of the pipe to be sawed.

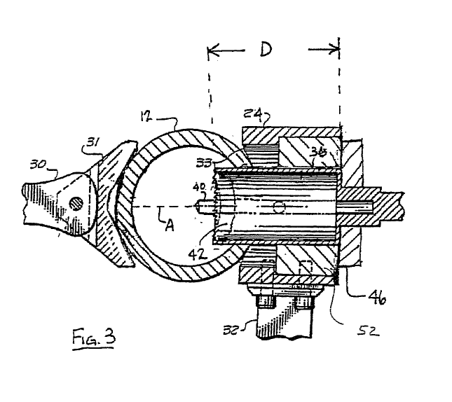

FIG. 3 illustrates the position of the hole saw 22 immediately after the sawed hole is formed in a pipe. In the exemplary embodiment, the sawed hole has a centerline A in the same plane as the centerline of pipe 12.

As the hole is sawed in pipe 12, a coupon 42 is formed. In the exemplary embodiment, the coupon is retained on the drill bit 40 for removal away from the sawed hole as the hole saw 22 is retracted from the axial opening 36. Stop member 46 of the exemplary embodiment is enabled to engage the guide member 24 to limit inward axial movement of the hole saw 22. Thus, in the exemplary arrangement the hole saw 22 is prevented from internally engaging the pipe wall at a diametrically opposed position from the hole.

The methods illustrated in FIGS. 2 and 3 for providing a sawed hole in a first side of pipe 12 are useful, for example, for adding a branch line to an existing pipe network. However, it is often desirable or necessary to add a cross-line to an existing pipe network. By “branch line” it is meant that one additional pipe length is added to an installed pipe such that the pipe interiors are in fluid communication, and the branch line extends in a first direction from the installed pipe. By “cross-line” it is meant that two generally co-axial pipe lengths are added to an installed pipe such that the pipe interiors are in fluid communication and the pipe lengths extend in diametrically opposed directions relative to the previously installed pipe.

The exemplary apparatus 10 may be utilized to determine the correct position for the opposite pipe length when adding a cross-line to pipe 12. In an exemplary embodiment, drill bit 40 may be utilized to form a pilot hole in the first side of the pipe wall and to retain the coupon 42 as earlier described. In an exemplary embodiment, after retracting the hole saw 22 from the axial opening 36, drill bit 40 may be replaced by drill bit 40a as shown in FIG. 4.

In the exemplary embodiment, drill bit 40a has a length L, as measured from stop member 46, sufficient to span the interior of pipe 12 when the hole saw is positioned within the axial opening 36. The drill bit 40a extends along the axis of hole saw 22 and is enabled to internally contact the pipe wall of pipe 12 at a position diametrically opposed to the first sawed hole. In locating the correct position of the internal marking pilot hole 50, the portable tool is retained in its initial user-determined position after a first hole is sawed. In an exemplary embodiment, the hole saw 22 is retracted out of the axial opening 36 in the guide member 24, and the pilot drill bit 40 (and coupon) are removed. A longer drill bit 40a is placed along the axis of the hole saw, and the hole saw is reinserted in the axial opening 36. Although the stop member 46 prevents the hole saw itself from contacting the opposite interior side of the pipe, the longer drill bit 40a contacts the pipe wall at the diametrically opposed position along centerline A. Operation of the power drill 25 rotates drill bit 40a to form the internal alignment marking pilot hole 50.

To saw the hole for the cross-line on the opposite side of the first hole, the portable tool 10 is repositioned to the opposite side of the pipe 12. The alignment pilot hole 50, which was previously drilled, provides a guide for the proper location of the opposed hole to be sawed. For example, the alignment pilot hole 50 operates as a pilot hole, and the horizontal level 26, vertical level 27, and center guides 28 are utilized to properly position the portable tool. With the portable tool repositioned, the hole saw with drill bit 40 installed, is reinserted into the axial opening 36, now on the opposite side of the pipe 12, and another hole is sawed. It is within the scope of the invention that the second drilled hole may have a diameter which is the same as or different from the diameter of the first sawed hole.

In some alternative embodiments, various approaches may be used. For example, the steps associated with producing the hole and pilot hole may be combined. In one exemplary embodiment, second drill bit 40a has a length sufficient to span the internal diameter of pipes having diameters of, for example, 2, 2½, and 3 inches. Pipes of other diameters are also contemplated within the scope of the invention. In other exemplary embodiments the apparatus 10 may include a greater number of selectable drill bits to span a variety of pipe diameters. Of course in other embodiments other approaches may be used.

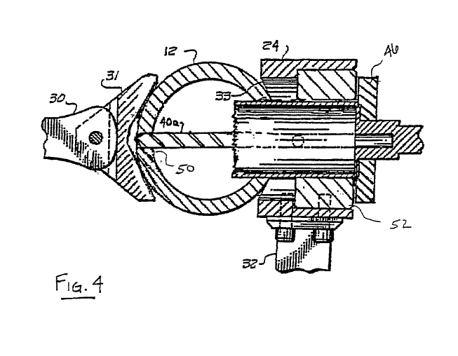

With reference to FIG. 5, in the exemplary embodiment, apparatus 10 includes a plurality of selectively replaceable bushings 52, 52a, 52b. The bushings 52 are operable to adjust the axial opening 36 of guide member 24 to accommodate a plurality of hole saws 22, 22a, 22b, of varying diameters. A hole saw, i.e., 22a, and an accompanying bushing, i.e., 52a, are selected in accordance with the desired diameter of the hole to be sawed in the pipe. In an exemplary embodiment, each bushing 52, 52a, 52b, has generally the same outer dimension so as to be selectively interchangeable in the axial opening. However, the inner dimensions differ in order to accommodate hole saws with different diameters. The hole saws can be used to cut hole sizes, for example, of 1½, 1¾, and 2 inches in diameter. Other hole sizes are contemplated within the scope of the invention.

With reference again to FIG. 1, the axial opening 36 is generally circular in cross section to mate with circular cross sections of bushings 52. It is within the scope of the invention to have an axial opening that is square, hexagonal, or other shape and the bushing to be constructed with mating outer dimensions.

As shown in FIGS. 3 and 4, in an exemplary embodiment, exemplary apparatus 10 further includes a plurality of selectable drill bits 40, 40a A first drill bit 40 may be used to provide a pilot hole in a first side of pipe 12. A second drill bit 40a may be used to provide an internally drilled alignment pilot hole at a location diametrically opposed to the sawed hole as previously described.

With reference again to FIG. 1, in an exemplary embodiment, apparatus 10 includes a radially extending annular stop member 46 in supporting connection with the hole saw 22. Stop member 46 includes a forward face that is positioned a predetermined distance D from the forward cutting edge 38 of hole saw 22. In operation, in an exemplary embodiment, guide member 24 and bushings positioned therein is enabled to cooperate with stop member 46 to limit inward axial movement of the hole saw in the axial opening 36. Thus, hole saw 22 is able to penetrate a first side of the pipe to be sawed, but prevented from internally contacting the diametrically opposed location.

In exemplary embodiments, the stop member 46 is a separate component that may be utilized with any selected hole saw 22. Thus the stop member 46 may comprise a ring-like structure that may be secured in operative connection with the power drill 25. In other exemplary embodiments, a stop member 46 and a hole saw 22 may comprise a unitary construction.

The stop member illustrated in FIG. 1 is merely exemplary and other devices or constructions may be utilized to limit the axial movement of the hole saw 22 relative the guide member 24. For example, the hole saw may include one or more radially extending protrusions a predetermined distance from the forward cutting edge.

A bushing of the types previously described, such as bushing 52 as shown, may be secured to guide member 24 within the axial opening in the manner disclosed in the incorporated reference, for example, by seating bushing 52 against a step surface and using one or more set screws tightening against one or more flat surfaces. Other means for releasably securing bushing 52 to guide member 24 may be used.

In exemplary embodiments, the guide member may be selected from a plurality of replaceable guide members wherein each guide member includes an axial opening corresponding to a hole saw diameter.

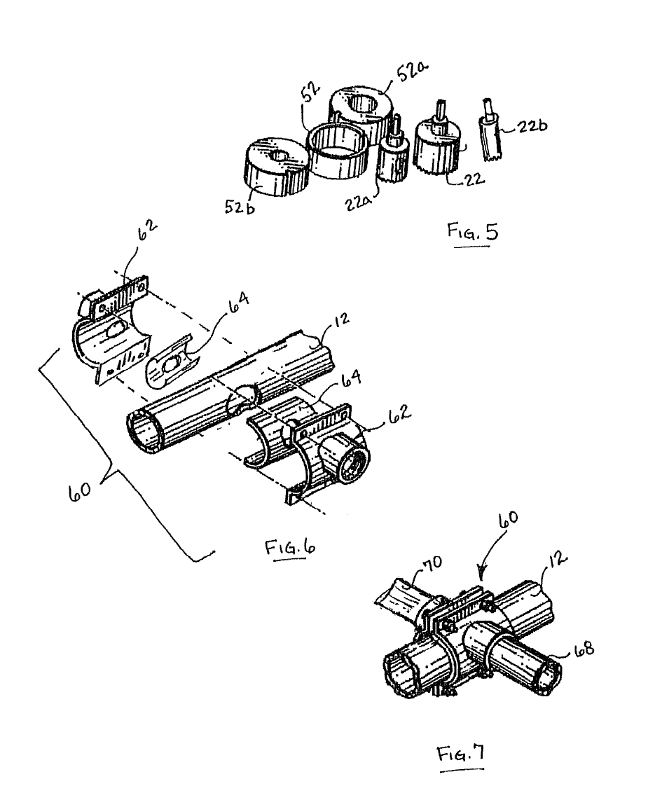

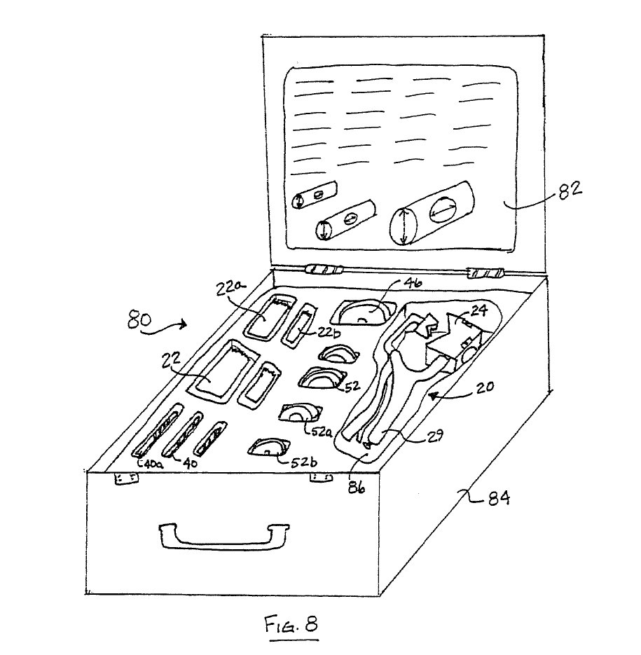

FIG. 6 illustrates an exemplary gasketed clamp fitting 60 including two bolt-on clamp ports 62 and a pair of resilient gaskets 64 to provide annular sealing around the sawed holes in pipe 12. FIG. 7 illustrates the pair of opposed pipe lengths 68, 70 that form the cross line in flow communication with pipe 12. In exemplary embodiments, pipes 68, 70 may be of a material and include one or more devices that enable engagement with ports 62 by threaded or other engagement devices that do not require a significant cure time to achieve suitable fluid tight pressurized connection. Clamp fitting 60 and associated fasteners are utilized to sealingly engage pipe lengths 68, 70 with the holes in pipe 12. Of course this approach is exemplary.

In an exemplary embodiment, illustrated in FIG. 8, apparatus 10 may be arranged as a kit 80 which includes a portable tool 20, including a guide member 24 and a clamping mechanism 29. The exemplary kit also includes a plurality of selectively replaceable drill bits 40, 40a, a plurality of selectively replaceable bushings 52, 52a, 52b, a plurality of selectively replaceable hole saws 22, 22a, 22b, and at least one stop member 46. In an exemplary embodiment, kit 80 may include a chart or other guide 82 to coordinate hole saw, bushing, and drill bit selection depending on the size of hole to be sawed and the diameter of pipe. The chart or guide assists a user in properly selecting the components to be used for a particular application. In the exemplary kit, the drill bits, hole saws, and stop member are adapted for use with a standard power drill. The kit may include a carrying case 84 with appropriate nesting recesses 86 for each component carried therein. The guide chart may be attached to the inside of a lid of the case. In some embodiments, the drill bits, bushings and hole saws may include indicia or color markings to assist selection. It is further contemplated within the scope of exemplary forms of the invention to provide a hole saw and a radially extending stop member having a unitary construction.

Thus, in an exemplary method, the preexisting sprinkler system including CPVC pipes, which are alternatively referred to herein as conduits, is relieved of fluid pressure. This may be done, for example, by closing water valves or other conduits that disconnect the sprinkler system pipes, to which a branch connection is to be made, from a source of fluid pressure. The pressure within the pipes is then relieved after the valve is closed. This can be done by opening an outlet or removing a sprinkler head, for example.

One or more locations for the branch connectors are then determined. Appropriate holes are drilled in the pipes, utilizing the devices and methods previously described. Of significance is that the existing pipe is not fully dried in the exemplary embodiment when carrying out this process. With the one or more holes drilled in the preexisting CPVC conduit, the external pipe seals and conduit clamping mechanisms are applied as shown in FIG. 6. The clamping mechanism is then secured about the pipe through fasteners as shown. This compresses the resilient gasket material between the outer wall of the pipe and the clamp fitting. This provides a fluid tight passage from each hole in the pipe to a corresponding clamp port. A fluid tight connection is made to suitable conduits 68, 70. Such conduits in some embodiments can be attached through devices where an absence of moisture is not necessary to achieve a suitable fluid tight, pressurized connection rapidly after connection. This can be done through threads, couplings, flanges or other suitable devices, for example.

As a result, through this exemplary method an existing sprinkler system including CPVC pipes can have branch sprinkler connections fluidly connected thereto without the need for extensive drying measures or prolonged curing periods for pipe joining materials. This may enable branching conduits to be connected, and the system placed back in operation, without the need for extended periods where the sprinkler system is inoperative and alternative fire watch measures need to be provided. Of course this method is exemplary, and in other embodiments the principles described may also be advantageous.

Thus, the systems and methods of exemplary forms of the present invention achieve at least one of the above stated objectives, eliminate difficulties encountered in the use of prior devices and arrangements, solve problems, and attain the desirable results described herein.

In the foregoing description, certain terms have been used for brevity, clarity and understanding, however, no unnecessary limitations are to be implied therefrom because such terms are for descriptive purposes and are intended to be broadly construed. Moreover, the descriptions and illustrations herein are by way of examples and the invention is not limited to the details shown and described. It is to be understood that various modifications and enhancements may be made without departing from the spirit and scope of the invention.

Further, in the following claims any feature that is described as a means for performing a function shall be construed as encompassing any means capable of performing that function and shall not be limited to the particular means shown in the foregoing description or mere equivalents.

Having described the features, discoveries, and principles of the invention, the manner in which it is constructed and operated, and the useful results attained; the new and useful structures, devices, elements, arrangements, parts, combinations, systems, equipment, operations, methods, and relationships are set forth in the appended claims.

What is claimed is:

1. Apparatus comprising:
at least one hole saw having a cylindrical body having a predetermined diameter,
wherein the at least one hole saw includes a forward cutting edge;
a stop member in supporting connection with the at least one hole saw disposed from the forward cutting edge a predetermined distance; and
a portable tool including a guide member and a clamping mechanism in supporting connection with the guide member, wherein the clamping mechanism is operative to securely hold the guide member in a user determined position relative a pipe to be sawed, wherein the guide member includes an axial opening adapted for reception of the at least one hole saw therein.

2. The apparatus according to claim 1 further comprising:
at least one selectable drill bit, wherein when selected, the drill bit is disposed along an axis of the at least one hole saw, wherein the selected drill bit has a length sufficient to provide a pilot hole in the pipe to be sawed.

3. The apparatus according to claim 2 wherein the selected drill bit has a length sufficient to span the internal diameter of the pipe to be sawed when the at least one hole saw is disposed within the axial opening.

4. The apparatus according to claim 3 wherein the at least one hole saw includes a plurality of selectively replaceable hole saws, wherein each of the plurality of hole saws comprises a cylindrical body having a corresponding predetermined diameter.

5. The apparatus according to claim 4 wherein the guide member includes a plurality of selectively replaceable bushings operative to selectively adjust a size of the axial opening to accommodate the plurality of hole saws therein.

6. The apparatus according to claim 5 wherein the guide member is enabled to cooperate with the stop member to limit axial movement of a selected hole saw in the axial opening.

7. The apparatus according to claim 6 wherein the stop member comprises a radially extending member adjacent an end of the selected hole saw opposite the forward cutting edge.

8. The apparatus according to claim 7 wherein the selected hole saw and the stop member comprise an integral assembly.

9. The apparatus according to claim 1 wherein the guide member is enabled to cooperate with the stop member to limit axial movement of the at least one hole saw in the axial opening.

10. The apparatus according to claim 1 wherein the stop member comprises a radially extending member adjacent an end of the at least one hole saw opposite the forward cutting edge.

11. The apparatus according to claim 1 wherein the at least one hole saw and the stop member comprise an integral assembly.

12. A method comprising:
a) engaging a pipe to be sawed with a portable tool, wherein the portable tool includes a guide member and a clamping mechanism operative to securely hold the guide member in a user determined position relative the pipe to be sawed, and wherein the guide member includes an axial opening adapted for reception of a first hole saw therein;
b) penetrating a pipe wall with a forward cutting edge of the first hole saw received within the axial opening, whereby a first sawed hole corresponding to a diameter of the first hole saw is formed in a wall of the pipe;
c) utilizing a stop member in cooperation with the guide member to prevent the forward cutting edge from internally contacting the pipe wall at a position diametrically opposed to the first sawed hole.

13. The method according to claim 12 further comprising:
d) subsequent to (b), without repositioning the portable tool, providing an internal alignment pilot marking hole in the pipe wall at the diametrically opposed position.

14. The method according to claim 13 wherein in (d), providing the internal alignment marking hole includes disposing a drill bit along an axis of the first hole saw, wherein the drill bit has a length sufficient to span an internal diameter of the pipe, and engaging an internal surface of the pipe wall with the drill bit at the diametrically opposed position while the first hole saw is received in the axial opening.

15. The method according to claim 13 further comprising:
e) subsequent to (d), repositioning the portable tool to enable a second sawed hole to be formed in the pipe wall at the diametrically opposed position.

16. The method according to claim 15, further comprising:
f) prior to (e), adjusting a size of the axial opening of the guide member to accommodate a second hole saw differing in diameter from the first hole saw.

17. The method according to claim 15 further comprising:
(f) connecting a first branch pipe length in flow communication with the pipe through the first sawed hole, and connecting a second branch pipe length in flow communication with the pipe through the second sawed hole, wherein the first and second branch pipe lengths are substantially coaxial.

18. The method according to claim 12 further comprising:
d) connecting a branch pipe length in flow communication with the pipe through the first sawed hole.

19. The method according to claim 17 wherein in (d) connecting the branch pipe length with the pipe includes using a mechanical fastener.

20. The method according to claim 12 further comprising:
(d) subsequent to (a), using a drill bit disposed along an axis of the first hole saw to form a pilot hole in the pipe wall and to retain a coupon of the sawed hole.

21. A method comprising:
a) guiding a hole saw through an axial opening in a guide member, wherein the hole saw includes a forward cutting edge;
b) penetrating a pipe wall with the hole saw thereby forming a first sawed hole in the pipe wall;
c) engaging a stop member with the guide member after the hole saw has penetrated the pipe wall and before the forward cutting edge engages the pipe wall at a diametrically opposed position;
d) drilling an internal alignment hole in the pipe wall at the diametrically opposed position.

22. The method of claim 21 wherein in (d), drilling the internal alignment hole includes disposing a drill bit along an axis of the hole saw, wherein the drill bit comprises a length sufficient to span an internal diameter of the pipe when the stop member is engaged with the guide member.

23. Tool kit comprising:
a plurality of hole saws;
at least one stop member;
a portable tool including a guide member having an axial opening therein;
a plurality of bushings adapted for reception within the axial opening;
at least one drill bit.
